(19) United States
(12) Patent Application Publication
(10) Pub. No.: US 2005/0277751 A1
(43) Pub. Date: Dec. 15, 2005

(54) Resin and a coating solution for forming insulating film, and a method for forming an insulating film

(75) Inventors: Naoya Satoh, Tsukuba-shi (JP); Akira Yokota, Matsudo-shi (JP); Nobutaka Kunimi, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/139,637

(22) Filed: May 31, 2005

(30) Foreign Application Priority Data
Jun. 2, 2004 (JP) 2004-164225
Jun. 2, 2004 (JP) 2004-164226

(51) Int. Cl. C08F 36/00

(52) U.S. Cl. 526/282; 526/346; 526/285

(57) ABSTRACT

The present invention provides a coating solution for forming insulating films, the formed film which having low relative dielectric constant and being excellent in evenness, and a resin employed for preparing the solution; and a method for forming insulating films excellent in evenness. The resin is obtained by thermally polymerizing a compound represented by the following formula (1) to have the weight-average molecular weight in a range equal to or more than 1000 and equal to or less than 500000 in terms of polystyrene measured by GPC analysis. The coating solution for forming insulating film comprises at least one of the resin. A method for forming an insulating film comprises steps of coating the coating solution on a substrate and then subjecting to heat treatment.

### FIELD OF THE INVENTION

The present invention relates to coating solutions for forming insulating film and resins applied therefor, and to methods for forming an insulating film.

The present invention also relates to composition for forming insulating film and methods for forming an insulating film by using the composition.

### BACKGROUND OF THE INVENTION

The delay of electric signal transfer rate, so-called wiring delay, has currently come to an issue in semiconductor device production due to requirement of much finer wiring application. To solve the wiring delay problem, various methods are suggested such as enhancement of performance of wires themselves, reduction of interference between aligned wires, and the like. To reduce the interference between aligned wires, enhancement of insulating film performance is proposed. To enhance the insulating film performance, development of insulating films having much lower relative dielectric constant have been desired.

As materials which have low relative dielectric constant value and are possible to produce insulating films excellent in insulating ability, a material applied with adamantane derivatives has been recently disclosed in JP-A No.2003-292878.

Further, to decrease relative dielectric constant value, a material which permits insulating films porous has been recently disclosed in U.S. Pat. No. 6,630,520.

### SUMMARY OF THE INVENTION

The disclosed material is not necessarily able to provide sufficient evenness in coating film formation process. And in semiconductor device production processes, metals for wiring are embedded in holes or ditches formed on insulating films; it is preferable that the diameter of such holes is as small as possible and the length thereof is more shorten to further enhance fineness of wiring.

Objects of the present invention are to provide coating solutions for forming insulating films, wherein the formed films have low relative dielectric constant and are excellent in evenness, and resins employed for preparing the solutions; and methods for forming insulating films excellent in evenness.

Another object of the present invention is to provide a composition for forming insulating film which can reduce diameter of pores produced in pore forming process, and a method for forming an insulating film.

The invention provides a resin prepared by thermally polymerizing a compound represented by the following formula (1) and having a weight-average molecular weight in a range equal to or more than 1000 and equal to or less than 500000 based on a polystyrene calibration standard measured by GPC analysis. 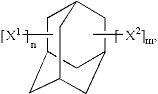
wherein X¹ is independently in each occurrence alkenyl group having 2 to 6 carbon atoms, alkynyl group having 2 to 6 carbon atoms, a monovalent organic group represented by the formula (2) or a monovalent organic group represented by the formula (3), X² is independently in each occurrence hydrogen atom, halogen atom, hydroxyl group, alkyl group having 1 to 6 carbon atoms, alkoxy group having 1 to 6 carbon atoms, phenoxy group or optionally substituted aryl group, n represents an integer of 2 to 16, and m is m=16-n; and
—Y¹—Ar¹ (2)
,wherein Y¹ represents alkenylene group having 2 to 6 carbon atoms or alkynylene group having 2 to 6 carbon atoms, and Ar¹ represents optionally substituted aryl group; and
—Y²—Ar²—(Y³-A)ₚ (3)
wherein Y² represents a single bond, alkylene group having 1 to 6 carbon atoms, alkenylene group having 2 to 6 carbon atoms or alkynylene group having 2 to 6 carbon atoms, Y³ is independently in each occurrence alkylene group having 1 to 6 carbon atoms, alkenylene group having 2 to 6 carbon atoms or alkynylene group having 2 to 6 carbon atoms, any one of Y² and Y³ is alkenylene group having 2 to 6 carbon atoms or alkynylene group having 2 to 6 carbon atoms, p is an integer of 1 to 5, Ar² represents optionally substituted arylene group, A is independently in each occurrence hydrogen atom or optionally substituted aryl group.

The invention also relates to a coating solution for forming insulating film which includes at least one of the resin, and a method for forming an insulating film which includes steps of coating the coating solution on a substrate and then subjecting to heat treatment.

Further, the invention provides a composition for forming insulating film comprising the resin as mentioned above and a compound for forming pores, and a method for forming an insulating film which including steps of coating the composition on a substrate and then subjecting to heat treatment.

### DETAILED DESCRIPTION OF THE INVENTION

The present invention will be explained in more detail below.

Examples of alkenyl group having 2 to 6 carbon atoms include vinyl group, aryl group, propenyl group, butenyl group, butadiynyl group and hexenyl group. The alkenyl group may be branched and site of double bond therein is not particularly limited. Examples of alkynyl groups having 2 to 6 carbon atoms include ethynyl group, propynyl group, butynyl group and hexynyl group. The alkynyl group may be branched and site of triple bond therein is not particularly limited.

The monovalent organic group represented by the formula (2) is explained. In the formula (2), Y¹ represents alkenylene group having 2 to 6 carbon atoms or alkynylene group having 2 to 6 carbon atoms. Specific examples of alkenylene group having 2 to 6 carbon atoms include vinylene group, propenylene group and butenylene group. Specific examples of alkynylene group having 2 to 6 carbon atoms include ethynylene group, propynylene group, butynylene group or butadiynylene group.

Ar¹ represents optionally substituted aryl group. Specific examples of optionally substituted aryl group include phenyl group, methylphenyl group, dimethylphenyl group, ethylphenyl group, diethylphenyl group, trimethylphenyl group, tetramethylphenyl group, pentamethylphenyl group, hydroxyphenyl group, methoxyphenyl group, ethoxyphenyl group, phenoxyphenyl group, fluorophenyl group, chlorophenyl group, bromophenyl group, iodophenyl group, nitrophenyl group, cyanophenyl group, carboxyphenyl group, methyloxycarbonylphenyl group, aminophenyl group, naphthyl group, methylnaphthyl group, dimethylnaphthyl group, ethylnaphthyl group, diethylnaphthyl group, trimethylnaphthyl group, tetramethylnaphthyl group, pentamethylnaphtyl group, hydroxynaphthyl group, methoxynaphthyl group, ethoxynaphthyl group, phenoxynaphthyl group, fluoronaphthyl group, chloronaphthyl group, bromonaphthyl group, iodonaphthyl group, nitronaphthyl group, cyanonaphthyl group, carboxynaphthyl group, methyloxycarbonylnaphthyl group, aminonaphthyl group, biphenyl group and anthracenyl group.

The monovalent organic group represented by the formula (3) is explained. In the formula (3), Y² represents a single bond, alkylene group having 1 to 6 carbon atoms, alkenylene group having 2 to 6 carbon atoms or alkynylene group having 2 to 6 carbon atoms. Examples of alkylene group having 1 to 6 carbon atoms include methylene group, ethylene group, propylene group, butylene group, pentylene group and hexylene group. The alkylene group may be branched. Examples of alkenylene group having 2 to 6 carbon atoms and alkynylene group having 2 to 6 carbon atoms, are same to the above described.

Y³ is independently in each occurrence alkylene group having 1 to 6 carbon atoms, alkenylene group having 2 to 6 carbon atoms or alkynylene group having 2 to 6 carbon atoms. Specific examples of alkenylene group having 2 to 6 carbon atoms and alkynylene group having 2 to 6 carbon atoms.

Any one of Y² and Y³ is alkenylene group having 2 to 6 carbon atoms or alkynylene group having 2 to 6 carbon atoms.

p is an integer of 1 to 5, Ar² represents optionally substituted arylene group. Specific examples of optionally substituted arylene group include alkylphenylene groups such as phenylene group, methylphenylene group, dimethylphenylene group, ethylphenylene group, diethylphenylene group, trimethylphenylene group, tetramethylphenylene group and pentamethylphenylene group; alkoxyphenylene groups such as methoxyphenylene group and ethoxyphenylene group; halophenylene groups such as fluorophenylene group, chlorophenylene group, bromophenylene group and iodophenylene group; alkylnaphthylene groups such as methylnaphthylene group, dimethylnaphthylene group, ethylnaphthylene group, diethylnaphthylene group, trimethylnaphthylene group, tetramethylnaphthylene group and pentamethylnaphtylene group; alkoxynaphthylene groups such as methoxynaphthylene group and ethoxynaphthylene group; halonaphthylene groups such as fluoronaphthylene group, chloronaphthylene group, bromonaphthylene group and iodonaphthylene group; hydroxyphenylene group, phenoxyphenylene group, nitrophenylene group, cyanophenylene group, carboxyphenylene group, methyloxycarbonylphenylene group, aminophenylene group, naphthylene group, hydroxynaphthylene group, phenoxynaphthylene group, nitronaphthylene group, cyanonaphthylene group, carboxynaphthylene group, methyloxycarbonylnaphthylene group, aminonaphthylene group, biphenylene group and anthracelene group.

A independently in each occurrence hydrogen atom or optionally substituted aryl group. Examples of optionally substituted aryl group is same to the above described.

The p is preferably 1 or 2.

It is preferable that X¹ contains carbon-carbon triple bond. That is, it is preferable that X¹ is alkynyl group having 2 to 6 carbon atoms, the monovalent organic group represented by the formula (2) in which Y¹ is alkynylene group having 2 to 6 carbon atoms, or the monovalent organic group represented by the formula (3) in which either Y² or Y³ is alkynylene group having 2 to 6 carbon atoms.

It is more preferable that X¹ is a monovalent organic group selected from the group consisting of

—C≡C—H —C≡C—Ar¹ —Ar²(—C≡C-A)ₚ —C≡C—Ar²(—C≡C-A)ₚ

, wherein Ar¹, Ar², A and p represent the same meaning described above; or 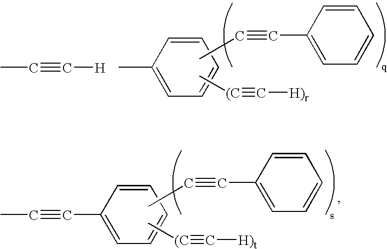
, wherein each of q, r, s and t independently represents an integer of 0 to 5, q+r is 1 to 5, and s+t is 0 to 5.

It is particularly preferable that X¹ is a monovalent organic group selected from the group consisting of

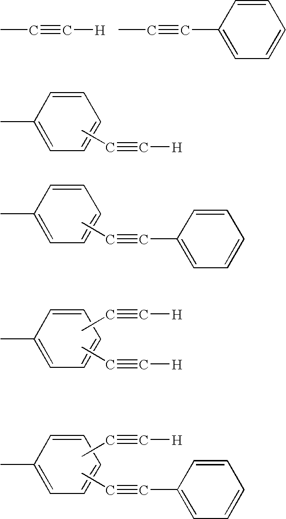

X independently in each occurrence hydrogen atom, halogen atom, hydroxyl group, alkyl group having 1 to 6 carbon atoms, alkoxy group having 1 to 6 carbon atoms, phenoxy group, or optionally substituted aryl group.

Halogen atoms include fluorine atom, chlorine atom, bromine atom and iodine atom.

Alkyl group having 1 to 6 carbon atoms include, for example, methyl group, ethyl group, propyl group, butyl group, and hexyl group.

Alkoxy groups having 1 to 6 carbon atoms include, for example, methoxy group, ethoxy group, propoxy group, butoxy group, and hexoxy group.

Optionally substituted aryl group includes, for example, alkylphenyl groups such as methylphenyl group, dimethylphenyl group, ethylphenyl group, diethylphenyl group, trimethylphenyl group, tetramethylphenyl group and pentamethylphenyl group; alkoxyphenyl groups such as methoxyphenyl group and ethoxyphenyl group; alkoxyphenyl groups such as fluorophenyl group, chlorophenyl group, bromophenyl group and iodophenyl group; alkylnaphthyl groups such as methylnaphthyl group, dimethylnaphthyl group, ethylnaphthyl group, diethylnaphthyl group, trimethylnaphthyl group, tetramethylnaphthyl group and pentamethylnaphtyl group; alkoxynaphthyl groups such as methoxynaphthyl group and ethoxynaphthyl group; halonaphthyl groups such as fluoronaphthyl group, chloronaphthyl group, bromonaphthyl group and iodonaphthyl group; phenyl group, hydroxyphenyl group, phenoxyphenyl group, nitrophenyl group, cyanophenyl group, carboxyphenyl group, methyloxycarbonylphenyl group, aminophenyl group, naphthyl group, hydroxynaphthyl group, phenoxynaphthyl group, nitronaphthyl group, cyanonaphthyl group, carboxynaphthyl group, methyloxycarbonylnaphthyl group, aminonaphthyl group, biphenyl group and anthracenyl group.

X² is preferably hydrogen atom, hydroxyl group or optionally substituted aryl group, more preferably hydrogen atom.

n represents an integer of 2 to 16, and m is m=16-n.

In view of synthesis, the compound represented by the formula (1) is preferably a compound selected from the following formulas: 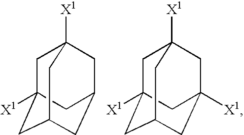
, wherein x¹ represents the same meaning described above.

Thermal polymerization of the compound represented by the formula (1) is explained. Thermal polymerization usually proceeds by inter-reaction between X¹s. Methods for thermally polymerizing the compound represented by the formula (1) are not particularly limited, a method for thermally polymerizing in a state dissolved in organic solvents is more preferably employed than thermally polymerizing as itself. The concentration dissolved in organic solvents not particularly limited, preferably in a range equal to or more than 1% by weight and equal to or less than 80% by weight, more preferably in a range equal to or more than 2% by weight and equal to or less than 50% by weight, and still more preferably in a range equal to or more than 5% by weight and equal to or less than 30% by weight. If the concentration is lower than the range, polymerization efficiency often deteriorates; if the concentration is higher than the range, viscosity of reactant during polymerization increases so much and often results in deterioration of handling ability.

The thermal polymerization is carried out at a temperature that X¹s are brought to reacting each other. If the temperature is too high, polymerization degree often falls out of control due to too accelerated reaction rate. If the temperature is too low, reaction never be brought or results in deterioration of reaction efficiency due to too low reaction rate.

Suitable temperature for thermal polymerization depends on the kind of compounds represented by the formula (1). When the compound represented by the formula (1) has a group represented by —C═C—H or —C═C—H, preferable thermal polymerization temperature is equal to or more than 50° C. and equal to or less than 3000, the more preferable is equal to or more than 80° C. and equal to or less than 200° C. When the compound represented by the formula (1) has neither a group represented by —C═C—H nor —C═C—H, preferable thermal polymerization temperature is equal to or more than 100° C. and equal to or less than 500° C., the more preferable is equal to or more than 150° C. and equal to or less than 300° C.

Organic solvents applied to dissolve the compound represented by the formula (1) for thermal polymerization, is not particularly limited, preferable are the solvents having boiling point higher than the temperature suitable for the thermal polymerization. In view of industrial availability and safety, specifically included are alcohol solvents such as methanol, ethanol, isopropanol, 1-butanol, 2-ethoxymethanol and 3-methoxypropanol; ketone solvents such as acetylacetone, methylethyl ketone, methylisobutyl ketone, 2-pentanone, 3-pentanone, 2-heptanone and 3-heptanone; ester solvents such as ethyl acetate, propyl acetate, butyl acetate, isobutyl acetate, pentyl acetate, ethyl propionate, propyl propionate, butyl propionate, isobutyl propionate, propyleneglycolmonomethylether acetate, methyl lactate, ethyl lactate and γ-butyrolactone; ether solvents such as diisopropyl ether, dibutyl ether, ethylpropyl ether, anisole, phenetole, and veratrole; and aromatic hydrocarbon solvents such as mesitylene, ethylbenzene, diethylbenzene and propylbenzene; and these solvents may be applied either alone or in a mixture of at least two thereof. Application of a solvent that is also employed for coating solutions, can eliminate solvent removal procedure in a process of forming coating solutions.

The resin prepared by thermally polymerizing the compound represented by the formula (1), has the weight-average molecular weight in a range equal to or more than 1000 and equal to or less than 500000 based on a polystyrene calibration standard measured by GPC analysis. The weight-average molecular weight based on a polystyrene calibration standard measured by GPC, is measured by known method.

The weight-average molecular weight based on a polystyrene calibration standard measured by GPC, is preferably in a range equal to or more than 2000 and equal to or less than 400000, more preferably equal to or more than 3000 and equal to or less than 200000.

If the weight-average molecular weight based on a polystyrene calibration standard measured by GPC analysis is smaller than the range, pore diameters often do not reduce to the required size. If the weight-average molecular weight based on a polystyrene calibration standard measured by GPC is larger than the range, solution viscosity used for coating often increases too high and results in deterioration of handling ability.

In thermally polymerizing the compound represented by the formula (1), a portion of the compound represented by the formula (1) may be left unreacted in the reactant. Mixture of the resin of the invention and the compound represented by the formula (1), may be applied as itself as a coating solution.

The coating solution for forming insulating film of the invention is prepared by subjecting the resin to dissolving to solvents, wherein the resin is prepared by thermally polymerizing the compound represented by the formula (1) and has the weight-average molecular weight based on a polystyrene calibration standard measured by GPC in a range equal to or more than 1000 and equal to or less than 500000. The organic solvents applied are not particularly limited, for example, in view of industrial availability and safety, preferably included are alcohol solvents such as methanol, ethanol, isopropanol, 1-butanol, 2-ethoxymethanol, and 3-methoxypropanol; ketone solvents such as acetylacetone, methylethyl ketone, methylisobutyl ketone, 2-pentanone, 3-pentanone, 2-heptanone, and 3-heptanone; ester solvents such as ethyl acetate, propyl acetate, butyl acetate, isobutyl acetate, pentyl acetate, ethyl propionate, propyl propionate, butyl propionate, isobutyl propionate, propyleneglycolmonomethylether acetate, methyl lactate, ethyl lactate, and γ-butyrolactone; ether solvents such as diisopropyl ether, dibutyl ether, ethylpropyl ether, anisole, phenetole, and veratrole; and aromatic hydrocarbon solvents such as mesitylene, ethylbenzene, diethylbenzene, and propylbenzene; and these solvents may be used either alone or in a mixture of at least two thereof.

The mixing ratio of the resin, which being prepared by thermally polymerizing the compound represented by the formula (1) and having the weight-average molecular weight based on a polystyrene calibration standard measured by GPC in a range equal to or more than 1000 and equal to or less than 500000, to the organic solvent is not particularly limited. The specific ratio is, depending on the required thickness of insulation film, preferably in a range of 1:99 to 50:50, more preferably 3:97 to 40:60.

The coating solution for forming insulating film of the invention may be added with compounds for forming pores. The compound for forming pores means a material which forms fine pores in insulating films by evaporation or decomposition at a stage of curing insulating films after coating the coating solution on a substrate.

A compound for forming pores includes, for example, olefin derivatives, polystyrene derivatives, polyalkyleneoxide derivatives, polyacrylicacid derivatives, polymethacrylicacid derivatives, polymethacrylicacid derivatives, polyalkyleneglycol derivatives, polyoxyether, polyester, polyamide and polycarbonate. Of these, preferably applied are polystyrene derivatives and polyalkyleneoxide derivatives.

Polystyrene derivatives include, for example, polystyrene, polyvinyltoluene, polyvinylxylene, poly-a-methylstyrene, poly-a-methylvinyltoluene, poly-a-methylvinylxylene, poly-a-ethylstyrene, poly-a-ethylvinyltoluene and poly-a-ethylvinylxylene. Of these, preferable are polystyrene, polyvinyltoluene, poly-a-methylstyrene and poly-a-methylvinyltoluene; more preferable being polystyrene and poly-a-methylstyrene.

Polyalkyleneoxide derivatives include, for example, polyoxymethylene, polyoxyethylene, polyoxypropylene and polyoxyisopropylene; preferably applied are polyoxyethylene and polyoxypropylene.

The compounds for forming pores may be coplymers copolymerized with at least two monomers. The copolymers includes, for example, polyoxyalkylene copolymers such as polyoxymethylene-polyoxyethylene copolymer, polyoxyethylene-polyoxypropylene coploymer and polyoxyethylene-polyoxypropylene coplymer; and styrene-methacrylate copolymer.

The compounds for forming pores may be appropriately chosen as far as compatibility with the component (A) being favorably maintained, and choice of a single kind or a combination of at least two kinds thereof may be applied.

Polystyrene equivalent weight-average molecular weight by GPC of the compounds for forming pores is preferably equal to or less than 50000, more preferably equal to or less than 30000, still more preferably equal to or less than 10000.

If the molecular weight exceeds 50000, large pores tend to be formed.

For the compounds for forming pores, to further enhance compatibility with the component (A), polymerization initiators, modifiers and polymerization terminators may be appropriately applied for polymerization reaction.

The polymerization initiators include, for example, organic metal compounds such as metal aryl compounds, metal alkyl compounds, salts of triphenylmethylcarbonium ion, peroxides having aromatic ring, and azo compounds having aromatic ring.

The modifiers includes, for example, 1,1-diphenylethylene, 1,2-diphenylethylene (cis-type, trans-type), 1,1,2-triphenylethylene and 1-naphthyl-1-penylethylene.

The polymerization terminators include, for example, water, methanol, halogenated alkyl compound and carbonyl compound.

Weight ratio of the resin to compound for forming pores in the composition for forming insulating film of the invention is preferably from 99:1 to 1:99, more preferably from 95:5 to 30:70.

If the weight ratio of the resin exceeds 99, numbers of formed pore reduce and relative dielectric constant does not often reach a sufficiently lowered level; if the weight ratio of the compounds for forming pores exceeds 99, compatibility between the resin and compounds for forming pores is deteriorated and large pores are often formed.

The composition comprising the resin and the compound for forming pores of the present invention may be used as a coating solution by blending with organic solvents. The same organic solvent as mentioned above may be used.

When being employed as a coating solution, value of [(the resin content+the compounds for forming pores content)/(the resin content+the compounds for forming pores content+organic solvent content)]×100 is preferably 5 to 50%. The concentration may be appropriately adjustable depending on specific objects such as thickness of coated film, improvement of unevenness filling ability or the like.

The composition for forming insulating film of the invention may be further added with additives.

The additives include, for example, coupling agents such as silane coupling agents, titanium coupling agents and the like, surfactants, foam stabilizers, catalysts of organic peroxides.

When organic films formed by the composition for forming insulating film of the invention is employed for insulating films or protection films of semiconductor device, it is especially preferable that the composition for forming insulating film of the invention is blended with a silane coupling agents to gain favorably high adhesiveness to a substrate; silane coupling agents having amino group, imino group or ketimino group are more preferable for blending.

Silane coupling agents having amino group, imino group or ketimino group include, for example, aminoethyltrimethoxysilane, aminoethyltriethoxysilane, aminoethyltriacetoxysilane, aminoethyltripropionylsilane, aminopropyltrimethoxysilane, aminopropyltriethoxysilane, aminoethylaminoethyltrimethoxysilane, aminoethylaminoethyltriethoxysilane, methyliminoethyltriethoxysilane, ethyliminoethyltriethoxysilane, hexyliminoethyltriethoxysilane, phenyliminoethyltriethoxysilane, dimethylketiminoethyltriethoxysilane, methylbutylketiminoethyltriethoxysilane, and methylphenylketiminotriethoxysilane.

An addition amount of silane coupling agent is preferably 0.01 to 40% in terms of weight ratio based on the component (A), more preferably 0.1 to 20%, still more preferably 1 to 10%.

An insulating film can be formed by coating the composition for forming insulating film of the invention on a substrate by an optional method such as spin coating, roller coating, dip coating or scanning and the like, and then being subjected to heat treatment.

The substrates include, for example, a substrate of glass, quartz, metals, ceramics, silicone, GaAs, SiO₂, SiN and SiC.

Heating treatment is not particularly limited, conventionally employed treatments such as hotplate heating, heating in a furnace, light-irradiation heating by RTP method (Rapid Thermal Processor) applying xenon lamp, or the like, may be employed.

The heating treatment is carried out preferably under the atmosphere of oxygen concentration of less than 1%, more preferably less than 100 ppm.

The oxygen concentration atmosphere of less than 1% includes, for example, reduced pressure atmosphere, inert gas atmosphere or vacuum.

The pressure of reduced pressure atmosphere is preferably about 1 to 20 Pa.

The inert gas includes, for example, helium, nitrogen or argon.

As mentioned above, the present invention provides a coating solution for forming insulating films, wherein the formed films have low relative dielectric constant and are excellent in evenness, and a resin employed for preparing the solution; and a method for forming an insulating film excellent in evenness.

The present invention also provides the composition for forming insulating film which can reduce diameter of pores produced in pore forming process, and the method for forming the insulating film.

### EXAMPLES

The present invention is explained in more detail by referring Examples, but should not be limited thereto.

### Production Example 1

Production of Resin 1

In a 2L four-necked flask, 100 ng of 1,3-bis(3,5-diethynylphenyl)adamantane was filled with 900 g of anisole to be dissolved. The dissolved solution was stirred at about 150° C. for 8 hours under an atmosphere of passing nitrogen through. The resin obtained was measured by GPC, resulting in 140000 of polystyrene equivalent weight-average molecular weight. 34% of monomer in terms of GPC integrated intensity, remained in the resin obtained.

### Production Example 2

Production of Resin 2

In a 50 mL three-necked flask, 3 g of 1,3-bis(3,5-diethynylphenyl)adamantane was filled with 27 g of anisole to be dissolved. The dissolved solution was stirred at about 150° C. for 8 hours under an atmosphere of passing nitrogen through. The resin obtained was measured by GPC, resulting in 113000 of polystyrene equivalent weight-average molecular weight. 35% of monomer in terms of GPC integrated intensity, remained in the resin obtained.

### Production Example 3

Production of Resin 3

In a 50 mL three-necked flask, 3 g of 1,3-bis(3,5-diethynylphenyl)adamantane was filled with 27 g of anisole to be dissolved. The dissolved solution was stirred at about 150° C. for 15 hours under an atmosphere of passing nitrogen through. The resin obtained was measured by GPC, resulting in 347000 of polystyrene equivalent weight-average molecular weight. 31% of monomer in terms of GPC integrated intensity, remained in the resin obtained.

### Production Example 4

Production of Resin 4

In a 50 mL three-necked flask, 3 g of 1,3-bis(3,5-diethynylphenyl)adamantane was filled with 27 g of anisole to be dissolved. The dissolved solution was stirred at about 150° C. for 10 hours under an atmosphere of passing nitrogen through. Thereafter, the solution was cooled down to 115° C., and then again subjected to reaction by gradually heating up to 135° C., followed by ceasing the reaction after totally 20 hours being elapsed. The resin obtained was measured by GPC, resulting in 57000 of polystyrene equivalent weight-average molecular weight. 42% of monomer in terms of GPC integrated intensity, remained in the resin obtained. This resin is named as Compound Al.

### Production Example 2

Production of Resin 5

In a 50 mL three-necked flask, 3 g of 1,3-bis(3,5-diethynylphenyl)adamantane was filled with 27 g of anisole to be dissolved. The dissolved solution was stirred at about 150° C. for 11 hours under an atmosphere of passing nitrogen through. The resin obtained was measured by GPC, resulting in 36000 of polystyrene equivalent weight-average molecular weight. 45% of monomer in terms of GPC integrated intensity, remained in the resin obtained. This resin is named as Compound A2.

### Production Example 6

Production of Compound for Forming Pores

Into a flask filled with nitrogen gas, 284 parts by weight of tetrahydrofuran and 72 parts by weight of a-methylstyrene were put. 54 parts by weight of n-butyllithium solution was dropped in the flask while the content being stirred. Thereafter, the flask was cooled down to −60° C., followed by the content being stirred for 30 minutes. Then, 165 parts by weight of 20% tetrahydrofuran solution of 1,1-diphenylethylene was dropped in the flask and then the content was stirred for 30 minutes. Finally, 6 parts by weight of methanol was added to the content to terminate reaction. After the content was heated up to a room temperature, the resin solution obtained was dropped in 4000 parts by weight of methanol to precipitate a resin, followed by filtering the precipitated resin. The poly-a-methylstyrene of which ends were modified with diphenylethylene and weight-average molecular weight was 1300, was obtained. This was applied as a compound for forming pores.

Preparation of Coating Solution

Preparation of Coating Solution 1

1,3-bis(3,5-diethynylphenyl)adamantane was dissolved with anisole to be 15% by weight of solid content. This solution was filtered with 0.1 μm PETF filter by a known art to prepare a coating solution.

Preparation of Coating Solution 2

Except that Resin 1 obtained by Production Example 1 was employed in place of 1,3-bis(3,5-diethynylphenyl)adamantane, the coating solution was prepared according to the manner employed to Coating solution 1.

Preparation of Coating Solution 3

Resin 2 obtained by Production Example 6 and Compound for forming pores obtained by Production Example 4 were blended with anisole to be dissolved in the manner that total solid content of the solution was 15% by weight and solid content ratio was 55:45 by weight. This solution was filtered with 0.1 μm PETF filter by a known art to prepare a coating solution.

Preparation of Coating solution 4

Except that Resin 3 obtained by Production Example 3 was employed in place of Resin 2 obtained by Production Example 2, the coating solution was prepared according to the manner employed to Coating solution 3.

Preparation of Coating solution 5

1,3-bis(3,5-diethynylphenyl)adamantane and Compound for forming pores obtained by Production Example 6 were blended with anisole to be dissolved in the manner that total solid content of the solution was 15% by weight and solid content ratio was 60:40 by weight. This solution was filtered with 0.1 μm PETF filter by a known art to prepare a coating solution.

Preparation of Coating Solution 6

Resin 5 by Production Example 4 and Compound for forming pores obtained by Production Example 6 were blended with anisole to be dissolved in the manner that total solid content of the solution was 15% by weight and solid content ratio was 55:45 by weight. This solution was filtered with 0.1 μm PETF filter by a known art to prepare a coating solution.

Preparation of Coating Solution 7

Except that Resin 5 obtained by Production Example 5 was employed in place of Resin 5 obtained by Production Example 4, the coating solution was prepared according to the manner employed to Coating solution 6.

### Example 1 to 3, Comparative Example 1 to 2

Each of prepared coating solution 1 to 5 was independently dropped in a volume of 1 ml by each on a 4-inch silicon wafer. Then the wafer was spun by rotating speed of 500 rpm for 3 seconds, followed by being spun by 2000 rpm for 15 seconds to be coated. The coated wafer was baked at 150° C. for 1 minute. Thereafter, the baked wafer was put in a furnace and then cured at 400° C. for 30 minutes under nitrogen atmosphere to decompose the compound for forming pores. The relative dielectric constant of the cured film obtained was measured by the capacitance-voltage measurement device (manufactured by Solid State Measurements, Inc., SSM495 type) using mercury probe in operating frequency of 1 MHz. The film thickness was measured at 25 spots selected on the surface of the 4-inch silicon wafer by the film thickness analyzer (manufactured by Nanometrics, Nanospec 6100A) to calculate film thickness uniformness (3s %) of the cured film. Measurement results are shown in Table 1 and 2.

TABLE 1

| | | | Film thickness |
|---|---|---|---|
| | | k Value | uniformity |
| | Coating solution | (1 MH_{z}) | (3s %) |
| Example 1 | Coating solution 1 | 12.74 | 2.4 |
| Comparative | Coating solution 2 | 2.85 | 9.9 |
| Example 1 | | | |

TABLE 2

| | | | Film thickness |
|---|---|---|---|
| | | k Value | uniformity |
| | Coating solution | (1 MH_{z}) | (3s %) |
| Example 2 | Coating solution 3 | 2.07 | 4.6 |
| Example 3 | Coating solution 4 | 2.02 | 4.5 |
| Comparative | Coating solution 5 | 2.09 | 7.0 |
| Example 2 | | | |

### Examples 4 and 5

Each of prepared coating solution 6 or 7 was independently dropped in a volume of 1 ml by each on a 4-inch silicon wafer. Then the wafer was spun by rotating speed of 500 rpm for 3 seconds, followed by being spun by 2000 rpm for 15 seconds to be coated. The coated wafer was baked at 150° C. for 1 minute. Thereafter, the baked wafer was put in a furnace and then cured at 400° C. for 30 minutes under nitrogen atmosphere to decompose the compound for forming pores. The relative dielectric constant of the cured film obtained was measured by the capacitance-voltage measurement device (manufactured by Solid State Measurements, Inc., SSM495 type) using mercury probe in operating frequency of 1 MHz. The cured film was measured by the X-ray generator (Ultra-X), goniometer (ATX-G type) and counting-recording device manufactured by RIGAKU to calculate the average pore size of cured film by analysis of the reflective component of small-angle X-Ray scattering. Measurement results are shown in Table 3.

TABLE 3

| | Coating | k Value | Pore size |
|---|---|---|---|
| | solution | (1 MH_{z}) | (nm) |
| Example 4 | Coating | 2.15 | 4.6 |
| | solution 6 | | |
| Example 5 | Coating | 2.09 | 4.8 |
| | solution 7 | | |

The film thickness uniformness of Example 1 is drastically improved in comparison with that of Comparative Example 1. The film thickness uniformnesses of Example 2 to 3 are drastically improved in comparison with that of Comparative Example 2.

The relative dielectric constants of Example 4 and 5 are in a range of 2.0 to 2.2, and their relative dielectric constants are drastically decreased and pore sizes are reduced.

1. A resin prepared by thermally polymerizing a compound represented by the formula (1) and having a weight-average molecular weight in a range equal to or more than 1000 and equal to or less than 500000 based on a polystyrene calibration standard measured by GPC analysis; 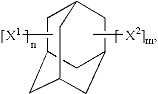
wherein X¹ independently in each occurrence alkenyl group having 2 to 6 carbon atoms, alkynyl group having 2 to 6 carbon atoms, a monovalent organic group represented by the formula (2) or a monovalent organic group represented by the formula (3), X² independently in each occurrence hydrogen atom, halogen atom, hydroxyl group, alkyl group having 1 to 6 carbon atoms, alkoxy group having 1 to 6 carbon atoms, phenoxy group or optionally substituted aryl group, n represents an integer of 2 to 16, and m is m=16-n;
—Y¹—Ar¹ (2)
wherein Y¹ represents alkenylene group having 2 to 6 carbon atoms or alkynylene group having 2 to 6 carbon atoms, and Ar¹ represents optionally substituted aryl group; and
—Y²—Ar²—(Y³-A)ₚ (3)
, wherein Y² represents a single bond, alkylene group having 1 to 6 carbon atoms, alkenylene group having 2 to 6 carbon atoms or alkynylene group having 2 to 6 carbon atoms, Y³ independently in each occurrence alkylene group having 1 to 6 carbon atoms, alkenylene group having 2 to 6 carbon atoms or alkynylene group having 2 to 6 carbon atoms, any one of Y² and Y³ is alkenylene group having 2 to 6 carbon atoms or alkynylene group having 2 to 6 carbon atoms, p is an integer of 1 to 5, Ar² represents optionally substituted arylene group, A independently in each occurrence hydrogen atom or optionally substituted aryl group.

2. The resin according to claim 1, wherein X¹ is alkynyl group having 2 to 6 carbon atoms, the monovalent organic group represented by the formula (2) in which Y¹ is alkynylene group having 2 to 6 carbon atoms, or the monovalent organic group represented by the formula (3) in which either Y² or Y³ is alkynylene group having 2 to 6 carbon atoms.

3. The resin according to claim 2, wherein X¹ is a monovalent organic group selected from the group consisting of
—C≡C—H —C≡C—Ar¹ —Ar²(—C≡C-A)ₚ —C≡C—Ar²(—C≡C-A)ₚ,
wherein Ar¹, Ar², A and p represent the same meaning described above.

4. The resin according to any one of claim 3, wherein X¹ is a monovalent organic group selected from the group consisting of 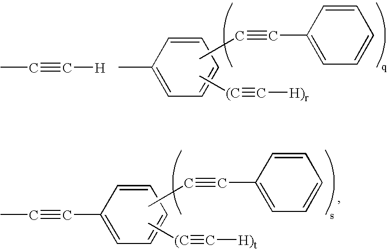
wherein each of q, r, s and t independently represents an integer of 0 to 5, q+r is 1 to 5, and s+t is 0 to 5.

5. The resin according to any one of claim 4, wherein X¹ is a monovalent organic group selected from the group consisting of

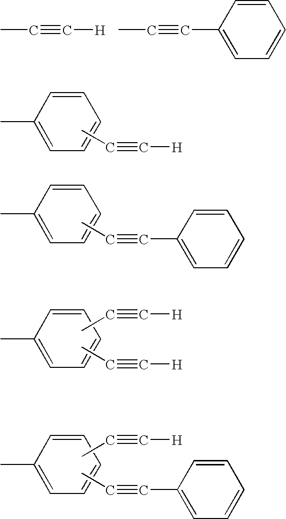

6. The resin according to any one of claim 1 to 5, wherein the compound represented by the formula (1) is a compound selected from the following formulas: 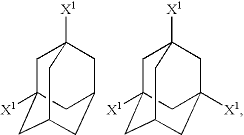
wherein x¹ represents the same meaning described above.

7. A coating solution for forming insulating film comprising at least one kind of the resins according to any one of claim 1 to 5.

8. A method for forming an insulating film comprising steps of coating the coating solution according to claim 7 on a substrate and then subjecting to heat treatment.

9. A composition for forming insulating film comprising a resin according to claim 1 and a compounds for forming pores.

10. The composition for forming insulating film according to claim 9, wherein X¹ is alkynyl group having 2 to 6 carbon atoms, the monovalent organic group represented by the formula (2) in which Y¹ is alkynylene group having 2 to 6 carbon atoms, or the monovalent organic group represented by the formula (3) in which either Y² or Y³ is alkynylene group having 2 to 6 carbon atoms.

11. The composition for forming insulating film according to claim 10, wherein X¹ is a monovalent organic group selected from the group consisting of
—C≡C—H —C≡C—Ar¹ —Ar²(—C≡C-A)ₚ —C≡C—Ar²(—C≡C-A)ₚ,
wherein Ar¹, Ar², A and p represent the same meaning described above.

12. The composition for forming insulating film according to claim 11, wherein X¹ is a monovalent organic group selected from the group consisting of 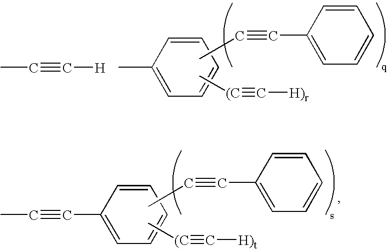
wherein each of q, r, s and t independently represents an integer of 0 to 5, q+r is 1 to 5, and s+t is 0 to 5.

13. The composition for forming insulating film according to claim 12, wherein X¹ is a monovalent organic group selected from the group consisting of

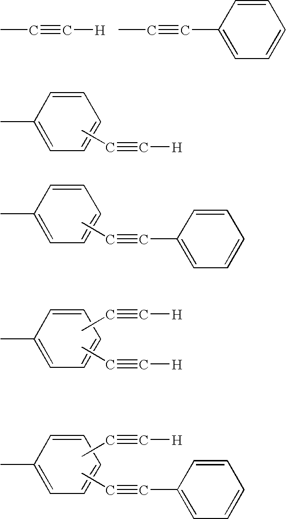

14. The composition for forming insulating film according to any one of claim 9 to 13, wherein the compound represented by the formula (1) is a compound selected from the following formulas: 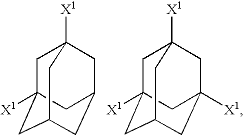
wherein x¹ represents the same meaning described above.

15. The composition for forming insulating film according to any one of claim 9 to 13, wherein the compounds for forming pores for forming pores is a compound containing polystyrene derivatives or poly-a-methylstyrene derivatives.

16. A coating solution for forming insulating film comprising at least one kind of the resins according to any one of claim 1 to 5 and a compounds for forming pores.

17. A method for forming an insulating film comprising steps of coating the coating solution according to claim 16 on a substrate and then subjecting to heat treatment.
